(19) United States
(12) Patent Application Publication
(10) Pub. No.: US 2003/0050839 A1
(43) Pub. Date: Mar. 13, 2003

(54) Method of distributing free-gift data and device for distributing free-gift data

(76) Inventor: Masashi Shiomi, Ueno-shi (JP)

Correspondence Address: BIRCH STEWART KOLASCH & BIRCH, PO BOX 747, FALLS CHURCH, VA, 22040-0747, US

(21) Appl. No.: 10/225,275

(22) Filed: Aug. 22, 2002

(30) Foreign Application Priority Data
Aug. 23, 2001 (JP) 2001-252636(P)

(51) Int. Cl. G06F 17/60

(52) U.S. Cl. 705/14

(57) ABSTRACT

Free-gift information attached to a product is transmitted by a purchaser of the product by means of a purchaser's terminal to a distribution server via a network, in order to request distribution of free-gift data which can be used by incorporating the data into software of the terminal. The distribution server checks whether or not the request for distribution is regular one and then requests the purchaser of the terminal to fill in a certain questionnaire. The distribution server receives the questionnaire to check if requisite items of the questionnaire are answered, and then transmits free-gift data corresponding to the received free-gift information to the terminal. In this way, the free-gift data which is usable by the terminal is distributed to the purchaser of the product. Distribution of such free-gift data continuously creates desire of consumers to buy products, which contributes to sales promotion.

### BACKGROUND OF THE INVENTION

1. Field of the Invention

The present invention relates to a method of distributing free-gift data and a device for distributing free-gift data via a communication line to a terminal, the free-gift data being usable by the terminal as additional data.

2. Description of the Background Art

According to one method of promoting the sale of products or goods, the products are sold each accompanied by a free gift in the form of a card or stickier on which a character of game software or TV animation program is printed.

According to another method, the appetite in consumers for shopping is aroused by mixing some premium cards or stickers into cards or stickers attached to the products and holding a drawing with a certain probability so as to select consumers who are to be given the premium cards or stickers.

For use as assistance in the sales promotion, questionnaires are attached to products that are to be filled out by those who buy the products with personal information and motivation for buying the products for example. Giveaways are presented to buyers selected by a drawing from those who answer the questionnaires, in order to increase the ratio of respondents (who answer the questionnaires) to the entire buyers and thus extract, from the abundant questionnaire data, data regarding buyers' ages and motivation for buying, for example.

A problem with the above-described methods is that the purpose of promoting the sale of products is not accomplished satisfactory for the reason hereinafter described. Suppose that the products are accompanied by such free gifts as goods associated with game software that is enjoying great popularity. If the free gifts are pictures or figures of some characters of the game software, or goods associated with the characters, those free gifts would contribute to the sales promotion only in the initial stage of the sales promotion immediately after starting distribution of the free gifts. However, it never occurs that such free gifts increase the appeal of the game itself. Accordingly, as the consumers are losing interest in the game, the consumers are also losing interest in the characters of the game, i.e., free gifts attached to the products.

In addition, with regard to the questionnaires attached to the products to be filled out by buyers from which some are selected and presented with giveaways, it is necessary that the products are purchased in a certain campaign period or that the filled-out questionnaires are sent by mail, which is troublesome to buyers.

Moreover, it is necessary that the buyers constantly check if the buyers are selected by the drawing. Instead, the buyers could be informed of the outcome of the drawing by the actual gifts sent to the buyers, which means that the buyers cannot know the outcome of the drawing immediately after the drawing is held. Further, if the campaign period is too long, the buyers could forget the campaign when the free gifts are sent to the buyers. Thus, such a sales promotion system as discussed above does not serve to arouse the appetite in consumers for buying.

### SUMMARY OF THE INVENTION

The present invention has been made to solve the above-described problem. One object of the present invention is to provide a method of distributing free-gift data by a computer system via a network to those who have purchased products, the free-gift data being usable by terminals, for the purpose of promoting the sale of products by continuously arousing the appetite in consumers for purchase.

Another object of the present invention is to provide a device for distributing free-gift data via a network to those who have purchased products, the free-gift data being usable by terminals, for the purpose of promoting the sale of products by continuously arousing the appetite in consumers for purchase.

According to the present invention, a method of distributing free-gift data by a computer system to a terminal is provided, the free-gift data being usable by the terminal as additional data. The method includes the steps of:

receiving a first notification of requesting distribution of the free-gift data from the terminal;

transmitting, to the terminal according to the first notification, a second notification of requesting transmission of free-gift information attached to and specific to a purchased product;

receiving the free-gift information transmitted from the terminal according to the second notification;

checking the received free-gift information against a free-gift information list containing the free-gift information for all products that have been delivered to determine whether or not the received free-gift information is regular free-gift information attached to the product; and

transmitting the free-gift data corresponding to the received free-gift information to the terminal, when it is determined that the received free-gift information is regular free-gift information attached to the product.

Preferably, the free-gift data distribution method further includes the steps of:

determining whether or not the free-gift data has already been transmitted, based on transmission information of the free-gift data corresponding to the received free-gift information;

inhibiting transmission of the free-gift data corresponding to the free-gift information to the terminal, when it is determined that the free-gift data has already been transmitted; and

when it is determined that the free-gift data has not been transmitted, updating the transmission information from data indicating that the free-gift data has not been transmitted to data indicating that the free-gift data has already been transmitted, after the free-gift data is transmitted to the terminal in the step of transmitting the free-gift data corresponding to the received free-gift information to the terminal when it is determined that the received free-gift information is regular free-gift information attached to the product.

Preferably, the free-gift data distribution method further includes the step of transmitting, to the terminal, a notification of requesting re-transmission of the free-gift information, when it is determined that the free-gift information is irregular free-gift information attached to the product in the step of checking the received free-gift information against the free-gift information list containing the free-gift information for all products that have been delivered to determine whether or not the received free-gift information is regular free-gift information attached to the product.

Preferably, the free-gift data distribution method further includes the steps of transmitting a questionnaire concerning the purchased product to the terminal and receiving the questionnaire from the terminal. Here, in the step of transmitting the free-gift data corresponding to the received free-gift information to the terminal when it is determined that the received free-gift information is regular free-gift information attached to the product, the free-gift data is transmitted to the terminal on the condition that requisite items of the received questionnaire are answered.

Preferably, the free-gift information includes product identification information and password information assigned to each product for identifying the product.

According to the present invention, a free-gift data distribution device for distributing free-gift data to a terminal is provided, the free-gift data being usable by the terminal as additional data. The free-gift data distribution device includes:

a communication unit for transmitting/receiving data to/from the terminal;

a first storage unit storing a free-gift information list containing the free-gift information for all products that have been delivered, the free-gift information being attached to and specific to the product, and a free-gift data identification code for specifying the free-gift data being associated with the free-gift information;

a second storage unit storing the free-gift data associated with the free-gift data identification code;

a determination unit obtaining the free-gift information list from the first storage unit and checking free-gift information received from the terminal against the free-gift information list to determine whether or not the received free-gift information is regular free-gift information attached to the product; and

a control unit providing the free-gift information received from the terminal via the communication unit to the determination unit and, according to the determination by the determination unit, obtaining from the second storage unit and transmitting to the terminal via the communication unit, the free-gift data specified by the free-gift data identification code associated with the free-gift information received from the terminal.

Preferably, the free-gift data distribution device further includes another determination unit determining, based on transmission information specified by the free-gift information received from the terminal, whether or not the free-gift data has not been transmitted. The first storage unit stores the transmission information of the free-gift data corresponding to the free-gift information, the transmission information being associated with the free-gift information attached to and specific to the product. The control unit provides the free-gift information received from the terminal via the communication unit to the determination unit and to that another determination unit, obtains from the second storage unit and transmits to the terminal via the communication unit, the free-gift data specified by the free-gift data identification code associated with the free-gift information received from the terminal based on the determinations by the determination unit and the another determination unit, updates, after transmitting the free-gift data, the transmission information from data indicating that the free-gift data has not been transmitted to data indicating that the free-gift data has already been transmitted, and stores the updated transmission information in the first storage unit.

Preferably, when the determination unit determines that the received free-gift information is irregular free-gift information attached to the product, the control unit transmits, to the terminal, a notification of requesting re-transmission of the free-gift information.

Preferably, the control unit transmits a questionnaire concerning the product which is purchased to the terminal via the communication unit, receives the questionnaire from the terminal via the communication unit, and transmits the free-gift data to the terminal via the communication unit on the condition that requisite items of the received questionnaire are answered.

Preferably, the free-gift distribution device further includes a third storage unit storing the questionnaire, as questionnaire information, received from the terminal via the communication unit.

Preferably, the free-gift information includes product identification information and password information assigned to each product for identifying the product.

As discussed above, by the free-gift data distribution method or the free-gift data distribution device according to the present invention, free-gift data usable by the terminal can immediately be distributed according to the free-gift information attached to a purchased product and transmitted from the terminal. The purchaser of the product thus easily obtains the free-gift data which can be used by being incorporated into software of the terminal. In this way, the appetite in consumers for purchase is continuously aroused.

Moreover, by the free-gift data distribution method or the free-gift data distribution device according to the present invention, the free-gift data is distributed while the issue of irregular acquisition of free-gift data is addressed. Distribution of free-gift data at any irregular request, which does not contribute to sales promotion, can thus be prevented.

Further, by the free-gift data distribution method or the free-gift data distribution device according to the present invention, free-gift data is supplied on the condition that a questionnaire is filled in, which can increase the number of returned questionnaires relative to all questionnaires transmitted to the purchasers. From the abundant questionnaire information, any valid data may be extracted for use in analysis of products, sales promotion and product development for example.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a configuration of a free-gift data distribution system according to the present invention.

FIG. 2 is a block diagram schematically showing a configuration of a distribution server of the free-gift data distribution system shown in FIG. 1.

FIG. 3 shows a structure of data stored in a first storage unit of the distribution server of the free-gift data distribution system shown in FIG. 1.

FIG. 4 shows a product with free-gift information attached by the free-gift data distribution system shown in FIG. 1.

FIG. 5 shows a product with free-gift information attached in a different manner from that shown in FIG. 4 by the free-gift data distribution system shown in FIG. 1.

FIG. 6 shows a structure of data stored in a second storage unit of the distribution server of the free-gift data distribution system shown in FIG. 1.

FIG. 7 shows a download image presented on a display unit of a terminal of the free-gift data distribution system shown in FIG. 1.

FIG. 8 shows another download image presented on the display unit of the terminal of the free-gift data distribution system shown in FIG. 1.

FIG. 9 shows a structure of data stored in a third storage unit of the distribution server of the free-gift data distribution system shown in FIG. 1.

FIG. 10 is a block diagram schematically showing a configuration of the terminal of the free-gift data distribution system shown in FIG. 1.

FIG. 11 shows a startup image for game software presented on the display unit of the terminal of the free-gift data distribution system shown in FIG. 1.

FIG. 12 shows an input image for entering free-gift information to the display unit of the terminal of the free-gift data distribution system shown in FIG. 1.

FIG. 13 is a first flowchart illustrating a process of the free-gift data distribution system shown in FIG. 1.

FIG. 14 is a second flowchart illustrating the process of the free-gift data distribution system shown in FIG. 1.

FIG. 15 is a third flowchart illustrating the process of the free-gift data distribution system shown in FIG. 1.

FIG. 16 is a fourth flowchart illustrating the process of the free-gift data distribution system shown in FIG. 1.

FIG. 17 shows a re-input request image on the display unit of the terminal of the free-gift data distribution system shown in FIG. 1.

FIG. 18 shows an image indicating that free-gift data is now being transferred, the image presented on the display unit of the terminal of the free-gift data distribution system shown in FIG. 1.

### DESCRIPTION OF THE PREFERRED EMBODIMENTS

An embodiment of the present invention is hereinafter described in detail in conjunction with the drawings. The same or corresponding components in the drawings are denoted by the same reference character and description thereof is not repeated.

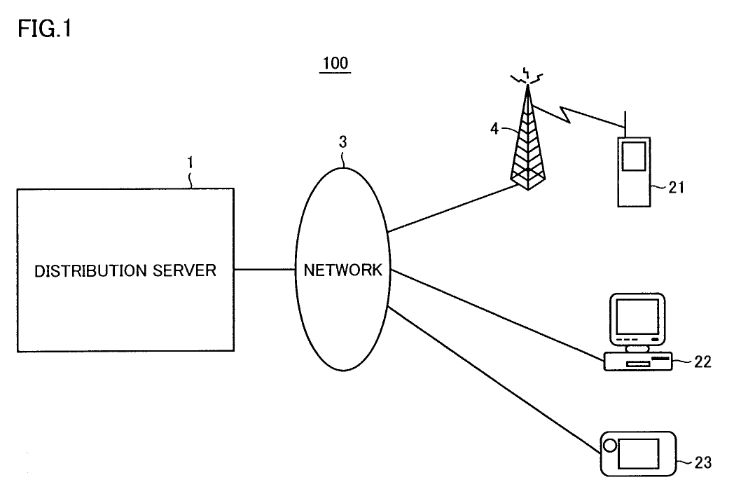

FIG. 1 shows an entire configuration of a free-gift data distribution system according to the present invention. Referring to FIG. 1, the free-gift data distribution system 100 includes a distribution server 1, terminals 21-23 and a network 3. Distribution server 1 and terminals 22 and 23 are connected to network 3, and terminal 21 which is a cellular phone is connected to network 3 via a mobile base station 4.

Distribution server 1 distributes free-gift data held therein to terminals 21-23 via network 3 at requests from terminals 21-23. If a purchaser of a product to which free-gift information is attached desires to obtain free-gift data, the purchaser enters the free-gift information into any of terminals 21 to 23 (hereinafter terminal 21-23). The information is sent from terminal 21-23 to be received by distribution server 1 via network 3. Distribution server 1 then determines whether the free-gift information sent from terminal 21-23 is regular one or not and accordingly determines whether or not the free gift data may be transmitted to terminal 21-23.

Moreover, distribution server 1 transmits a questionnaire regarding the purchased product to terminal 21-23 via network 3 and receives via network 3 the questionnaire answered and returned from terminal 21-23. On the condition that terminal 21-23 returns the answered questionnaire, distribution server 1 transmits, to terminal 21-23 via network 3, the free-gift data corresponding to the free-gift information sent from terminal 21-23.

Terminal 21-23 is used by the purchaser of the product with the free-gift information for obtaining and using the free-gift data supplied from distribution server 1. The user of terminal 21-23 transmits the free-gift information attached to the purchased product from terminal 21-23 to distribution server 1. The user thus requests distribution server 1 to distribute the free-gift data.

Terminal 21-23 receives via network 3 the questionnaire. On the condition that the questionnaire is answered, the free-gift data is supplied. Then, terminal 21-23 returns the answered questionnaire to distribution server 1 via network 3. Accordingly, terminal 21-23 obtains the free-gift data corresponding to the free-gift information attached to the purchased product from distribution server 1 via network 3.

Network 3 may be the Internet for example serving as a data communication channel for two-way data communication between distribution server 1 and terminal 21-23.

Mobile base station 4 is a relay station for connecting terminal 21 which is a cellular phone to network 3.

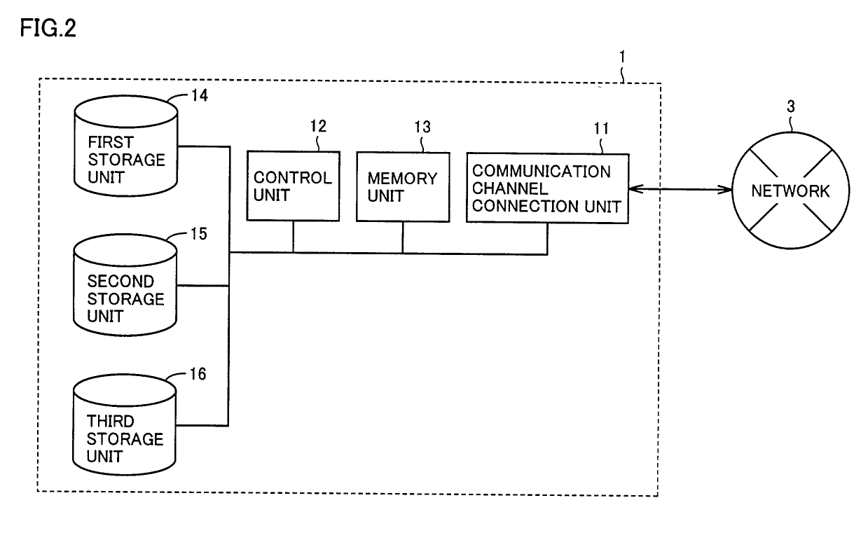

Referring to FIG. 2, distribution server 1 includes a communication channel connection unit 11, a control unit 12, a memory unit 13, a first storage unit 14, a second storage unit 15, and a third storage unit 16.

Communication channel connection unit 11 serves to communicate data between distribution server 1 and network 3.

Control unit 12 serves to determine whether or not free-gift information received via network 3 from terminal 21-23 is regular free-gift information, determine whether or not free-gift data corresponding to the free-gift information may be transmitted, obtain the free-gift data corresponding to the free-gift information from the second storage unit 15, and transmit the obtained free-gift data to terminal 21-23, for example.

Memory unit 13 is constituted of a RAM (Random-Access Memory) which is a working memory for operation of control unit 12 and a ROM (Read-Only Memory) holding an execution program for example of control unit 12.

The first storage unit 14 stores, for all of the products that have been delivered, free-gift information constituted of a password and a product ID attached for identifying each of the delivered products, a DATA-ID for specifying free-gift data corresponding to the free-gift information, and transmission information about whether or not the free-gift data corresponding to the free-gift information has been transmitted, for example.

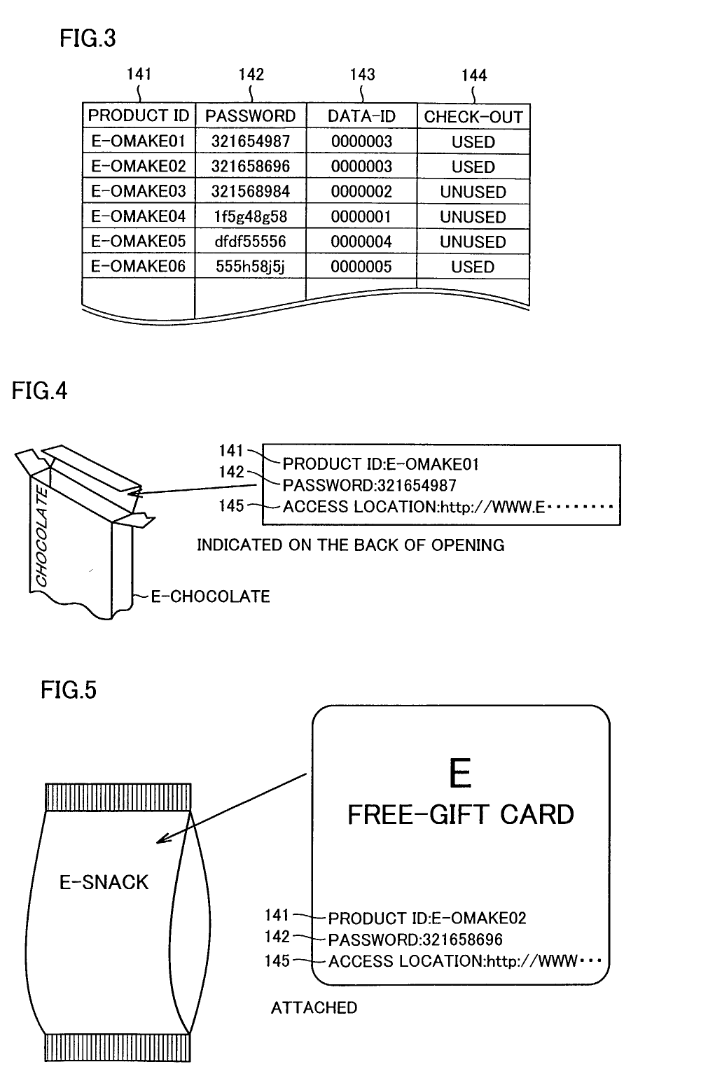

Referring to FIG. 3, the data stored in the first storage unit 14 includes a product ID 141, a password 142, a DATA-ID 143, and a CHECKOUT 144 indicating transmission information of free-gift data. In the first storage unit 14, password 142, DATA-ID 143 and CHECK-OUT 144 are associated with product ID 141 attached to each product and stored.

Product ID 141 is an identification code specific to each product that is allocated to each of all delivered products to which free-gift information is attached. Password 142 is used for preventing distribution of free-gift data in response to any irregular distribution request for the free-gift data. DATA-ID 143 is an identification code allocated to each of free-gift data of multiple types for specifying each free-gift data.

CHECK-OUT 144 indicates transmission information that whether or not free-gift data in question was transmitted in the past, in order to prevent irregular acquisition of the free-gift data. CHECK-OUT 144 indicating “used” means that free-gift data corresponding to free-gift information attached to a product has already been transmitted. Then, distribution server 1 determines that a request for distribution of this free-gift data is irregular request. In this case, the free-gift data is not transmitted to terminal 21-23.

CHECK-OUT 144 indicating “unused” means that free-gift data corresponding to free-gift information attached to a product has not been transmitted. Then, distribution server 1 determines that a request for distribution of the free-gift data is regular request to transmit the free-gift data specified by the associated DATA-ID 143 to terminal 21-23. After the free-gift data is transmitted to terminal 21-23, CHECK-OUT 144 is written as “used” by control unit 12.

Referring to FIG. 4, free-gift information attached to a product includes product ID 141 and password 142 that are printed on the inside of the product package, so that the free-gift information cannot be seen from the outside. An access location 145 is printed on the package together with product ID 141 and password 142. Access location 145 indicates the address (URL) of distribution server 1 that is accessed from terminal 21-23 by a purchaser of the product. Accordingly, product ID 141 and password 142 attached to the product are transmitted to distribution server 1. As shown in FIG. 5, product ID 141, password 142 and access location 145 may be printed on a free-gift card for example which is contained in the package of the product.

Referring again to FIG. 2, the second storage unit 15 stores, for example, free-gift data specified by DATA-ID 143 and data regarding a download image on a display unit of terminal 21-23 for allowing download of free-gift data into terminal 21-23.

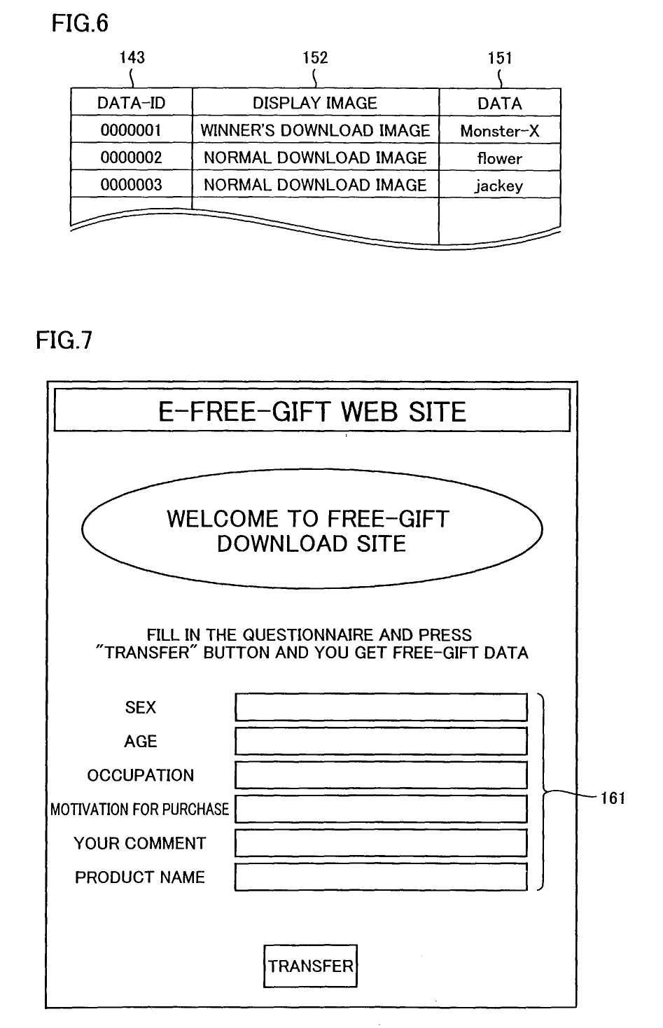

Referring to FIG. 6, the data stored in the second storage unit 15 includes DATA-ID 143, DATA 151 which is free-gift data itself, and display image data 152 for download to be indicated on the display unit of terminal 21-23 for downloading free-gift data into terminal 21-23. The second storage unit 15 associates DATA 151 and display image data 152 with DATA-ID 143 and stores them.

Multiple types of free-gift data are provided. DATA 151 may be of different characters or of a certain character in different poses or motions. Display image data 152 of a normal download image or winner's download image is selected depending on whether free-gift data is normal free-gift data or premium data of “winner.”

FIG. 7 shows a download image displayed on terminal 21-23 to present display image data 152 for normal free-gift data, and FIG. 8 shows a download image displayed on terminal 21-23 to present display image data 152 for premium data of “winner.”

These images include a space 161 of a questionnaire to be filled in. On the condition that the questionnaire is answered, free-gift data is supplied. As shown in FIGS. 7 and 8, the questionnaire includes respective sections for sex, age, occupation, motivation for purchase of the product, comment, and name of the purchased product for example. The user of terminal 21-23 who desires to obtain free-gift data fills in the questionnaire 161 on the down load image to transmit information of the questionnaire to distribution server 1.

Referring again to FIG. 2, the third storage unit 16 stores the questionnaire information received from terminal 21-23. The questionnaire information is thus data concerning the answer to the questionnaire from the user of terminal 21-23. The user is asked to fill in the questionnaire in order to obtain free-gift data.

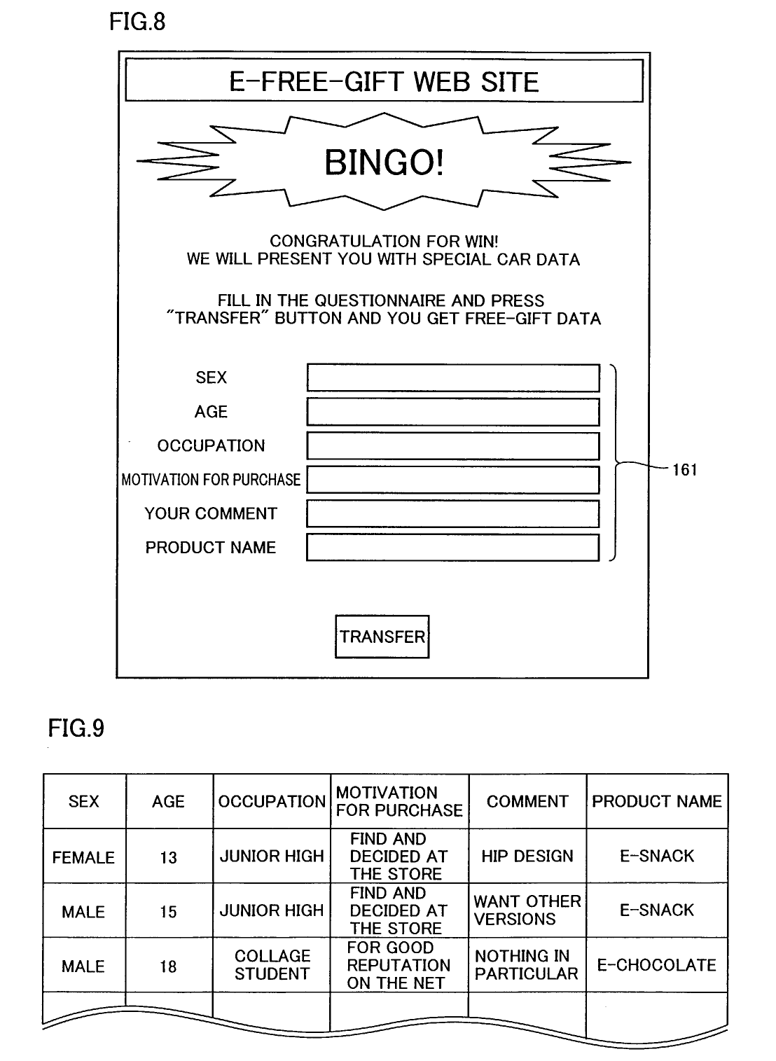

Referring to FIG. 9, the questionnaire information stored in the third storage unit 16 includes data of the user's (of the purchaser of the product) sex, age, occupation, motivation for purchase of the product and comment as well as the product name, for example, that are entered in the questionnaire space 161 on the download image displayed on terminal 21-23. The questionnaire information may be used by the company manufacturing or selling the product for the purpose of marketing analysis, product analysis and development of new products for example.

Referring again to FIG. 2, communication channel connection unit 11 in distribution server 1 receives free-gift information from terminal 21-23 via network 3 to write the free-gift information into memory unit 13. The free-gift information is thus written in memory unit 13, and then control unit 12 obtains, from the first storage unit 14, password 142, DATA-ID 143 and CHECK-OUT 144 corresponding to the product ID of the received free-gift information and writes them into memory unit 13.

If no product ID 141 corresponding to the product ID of the received free-gift information is found in the first storage unit 14, control unit 12 determines that the free-gift information is irregular one. Then, control unit 12 informs terminal 21-23 of this determination via communication channel connection unit 11 and network 3. Control unit 12 compares the password of the free-gift information received from terminal 21-23 with password 142 obtained from the first storage unit 14 to determine if they match.

Further, control unit 12 checks if CHECK-OUT 144 obtained from the first storage unit 14 indicates “used” or “unused.” If the passwords match and CHECK-OUT 144 indicates “unused,” control unit 12 reads, from the second storage unit 15, DATA 151 specified by DATA-ID 143 obtained from the first storage unit 14 according to the free-gift information and writes the read DATA 151 into memory unit 13.

Control unit 12 further reads, from the second storage unit 15, display image data 152 associated with DATA-ID 143 and writes the data into memory unit 13. Control unit 12 requests communication channel connection unit 11 to transmit display image data 152 to terminal 21-23. At the request from control unit 12, communication channel connection unit 11 reads display image data 152 from memory unit 13 and transmits the read data to terminal 21-23 via network 3.

From terminal 21-23 via network 3, communication channel connection unit 11 receives the questionnaire information entered in the download image of display image data 152 on terminal 21-23. Then, communication channel connection unit 11 writes the received information into the third storage unit 16. Control unit 12 receives the questionnaire information from terminal 21-23 to check if predetermined sections of the questionnaire are filled in. Then, control unit 12 requests communication channel connection unit 11 to read DATA 151 from memory unit 13 and transmit the data to terminal 21-23. Accordingly, communication channel connection unit 11 reads DATA 151 from memory unit 13 to transmit the data to terminal 21-23.

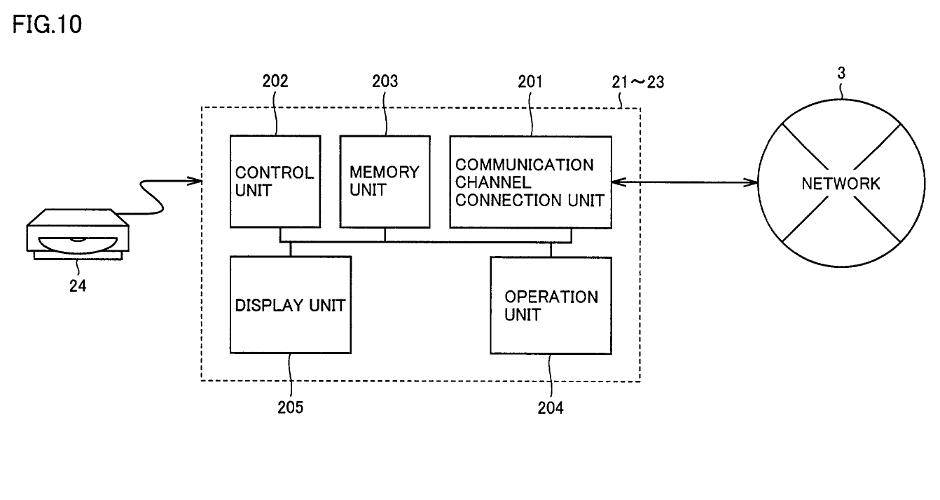

Referring to FIG. 10, terminal 21-23 includes a communication channel connection unit 201, a control unit 202, a memory unit 203, an operation unit 204, and a display unit 205. Terminal 21-23 is connected to a recording medium control unit 24 with a recording medium recorded a program in which free-gift data can be built.

Communication channel connection unit 201 communicates data between terminal 21-23 and network 3. For terminal 21 which is a cellular phone, communication channel connection unit 201 transmits/receives data to/from network 3 via mobile base station 4 (not shown).

Control unit 202 reads the program which can be used together with the free-gift data from the recording medium via recording medium control unit 24, and operates in accordance with the program. This program may be a program of game software for example. The free-gift data can be built in the program to improve the function of the game.

Moreover, control unit 202 transmits free-gift information entered from operation unit 204 to distribution server 1, transmits, to distribution server 1, questionnaire information entered from operation unit 204 into a download image indicated on display unit 205, and outputs various image data supplied from distribution server 1 onto display unit 205. In addition, control unit 202 starts the above-described program in which the free-gift data obtained from distribution server 1 is built.

Memory unit 203 is constituted of a RAM which is a working memory on which control unit 202 operates and a ROM in which an execution program of control unit 202 is stored for example.

Operation unit 204 is a input device for allowing a user of terminal 21-23 to enter free-gift information attached to the purchased product as well as answers to the questionnaire in order to obtain free-gift data.

Display unit 205 is a display device presenting an input image for entering the free-gift information or a download image for free-gift data that includes a space in which answers to the questionnaire concerning the product are entered.

Following an instruction of a user of terminal 21-23 given from operation unit 204, control unit 202 of terminal 21-23 reads, from recording medium control unit 24, the program to which free-gift data can be added, and then writes the program into memory unit 203. Control unit 202 starts the program following an instruction of the user from operation unit 204, and outputs data of a startup image to display unit 205. Then, display unit 205 presents the startup image data.

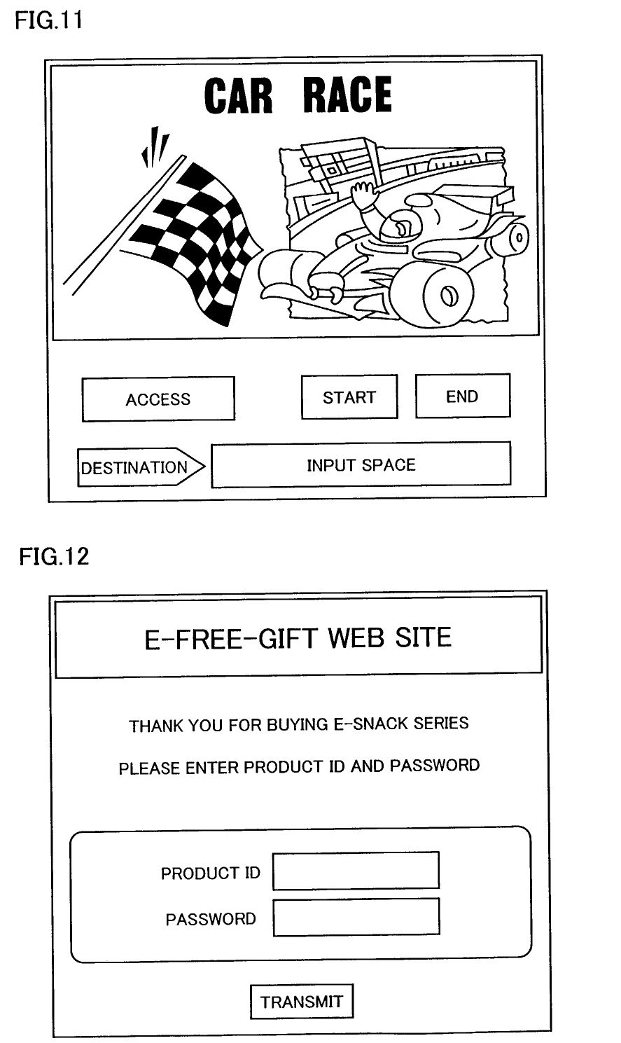

FIG. 11 shows a startup image appearing on display unit 205 when a program of game software is started, that is one example of the program which can be used together with free-gift data built-in thereto. The startup image includes a space for entering therein the address of a destination from which free-gift data is supplied. The user of terminal 21-23 uses operation unit 204 to enter the address (URL) of access destination 145 included in the free-gift information attached to the purchased product. Accordingly, terminal 21-23 is connected to the access destination, i.e., distribution server 1, via network 3.

Referring back to FIG. 10, terminal 21-23 is thus connected via network 3 to distribution server 1. Then, communication channel connection unit 201 receives, from distribution server 1 via network 3, data of an input image for entering free-gift information, and writes the received input image data into memory unit 203. Control unit 202 reads the received input image data from memory unit 203 to output the data onto display unit 205.

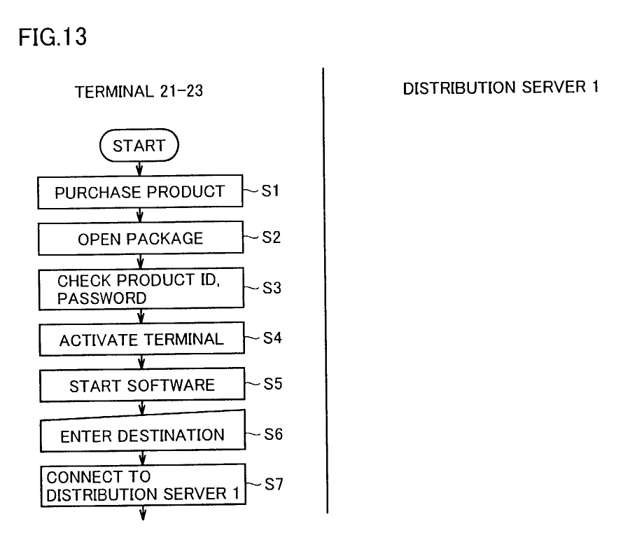

FIG. 12 shows the input image for entering the free-gift information that is presented on display unit 205. The user of terminal 21-23 enters, from operation unit 204, the free-gift information attached to the purchased product, namely, the product ID and password in the input image.

Referring again to FIG. 10, control unit 202 writes the free-gift information entered from operation unit 204 by the user of terminal 21-23 into memory unit 203, and instructs communication channel connection unit 201 to transmit the free-gift information to distribution server 1. Communication channel connection unit 201 reads the free-gift information from memory unit 203 to transmit the information via network 3 to distribution server 1.

Communication channel connection unit 201 receives, from distribution server 1 via network 3, data of the download image for obtaining free-gift data, and then writes the data of the download image into memory unit 203. Control unit 202 reads the download image data from memory unit 203 to output the data onto display unit 205.

When the user of terminal 21-23 enters questionnaire information from operation unit 204 in the download image, control unit 202 writes the entered questionnaire information into memory unit 203 and instructs communication channel connection unit 201 to transmit the questionnaire information to distribution server 1. Communication channel connection unit 201 reads the questionnaire information from memory unit 203 to transmit the questionnaire information to distribution server 1 via network 3.

Communication channel connection unit 201 receives free-gift data from distribution server 1 via network 3 and writes the received free-gift data into memory unit 203. Control unit 202 builds the received free-gift data in the program read from recording medium control unit 24 to start the program.

Referring now to FIGS. 13-16, a flow of a process of distributing free-gift data from distribution server 1 to terminal 21-23 is described according to this embodiment.

According to the embodiment, terminal 21-23 is equipped with game software adaptable to any electronic free-gift. It is supposed here, for the purpose of illustration, that a purchaser of a snack with free-gift information attached thereto receives free-gift data distributed from distribution server 1. Here, the free-gift data can be built in the game software. More specifically, the game software is car race software, and the free-gift data is data of such a part as tire of a race car or data of a special car for example that is supplied from distribution server 1.

Referring to FIG. 13, the user of terminal 21-23 equipped with car race game software gets to know through any web site, TV, newspaper, magazine, store or word-of-mouth, for example, that a certain snack (product) is sold with a free gift of parts that can be built in the car race game. Then, the user purchases such a snack with an electronic free-gift at a convenience store, snack shop or supermarket for example (step S1). The user purchased the product (hereinafter “product purchaser”) opens the package of the product (step S2) and checks the product ID, password and address (URL) of the destination from which the free-gift data can be obtained, that are printed on the inside of the package (step S3).

The product purchaser activates terminal 21-23 (step S4) and then starts the car race game software read from recording medium control unit 24 (step S5). The product purchaser enters the address (URL) of the destination printed on the package into the space on the startup image as shown in FIG. 11 for entering the destination address (step S6), and accordingly connects terminal 21-23 to distribution server 1 (step S7).

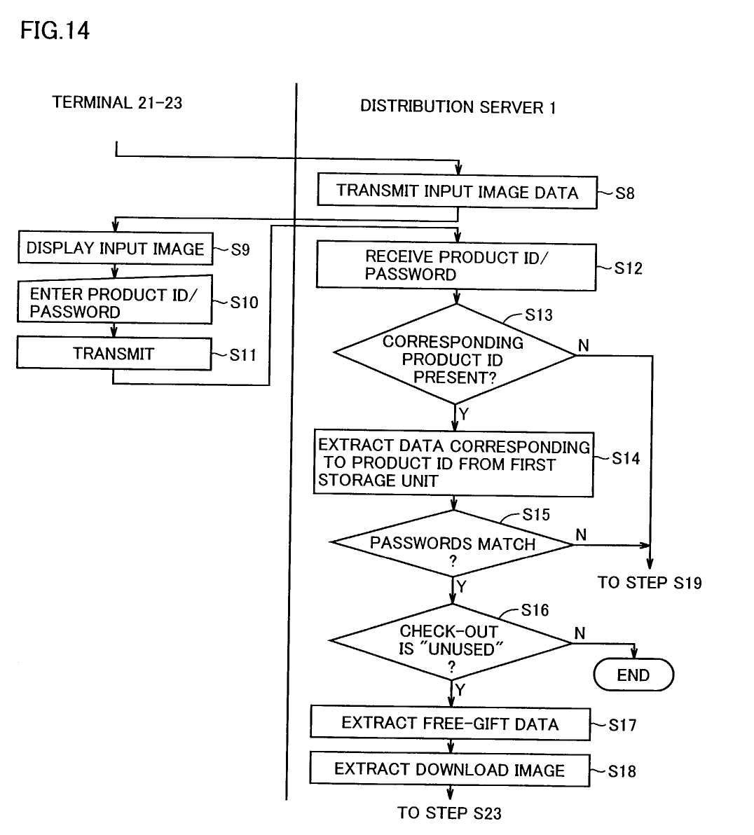

Referring to FIG. 14, terminal 21-23 is thus connected to distribution server 1 via network 3, and distribution server 1 transmits to terminal 21-23 via network 3 data of an input image on the screen to allow terminal 21-23 to enter the free-gift information (step S8). Communication channel connection unit 201 of terminal 21-23 receives the data of the input image from distribution server 1 via network 3, and writes the received input image into memory unit 203. Control unit 202 reads the input image data from memory unit 203 and outputs the data to display unit 205 which accordingly presents the input image as shown in FIG. 12 (step S9).

The product purchaser uses operation unit 204 to enter the product ID and the password indicated on the purchased product to the input image presented on display unit 205 (step S10). Control unit 202 transmits the entered product ID and password to distribution server 1 via communication channel connection unit 201 and network 3 (step S11).

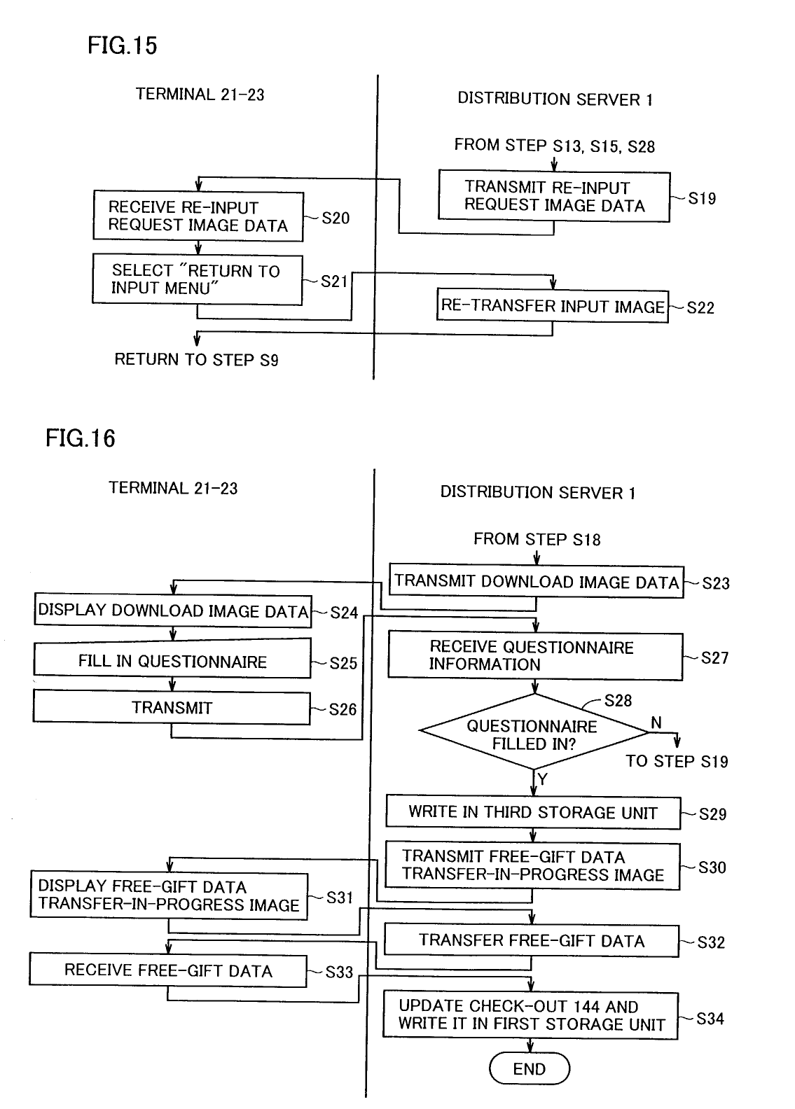

Control unit 12 of distribution server 1 receives the product ID and the password of the product purchased by the user of terminal 21-23 from terminal 21-23 via communication channel connection unit 11 (step S12). Then, control unit 12 check if the received product ID is included in the first storage unit 14 (step S13). If control unit 12 determines that the received product ID is not included in the first storage unit 14 (step S13), the process proceeds to step S19 shown in FIG. 15 described later.

If control unit 12 determines that the received product ID is included in the first storage unit 14 (step S13), control unit 12 reads from the first storage unit 14 password 142, DATA-ID 143 and CHECK-OUT 144 corresponding to the product ID (step S14). Then, control unit 12 checks whether or not the password received from terminal 21-23 match the password read from the first storage unit 14 (step S15). If the passwords do not match (step S15), control unit 12 determines that this request is an irregular request for free-gift data and the process proceeds to step S19 in FIG. 15 described later.

If the passwords match (step S15), control unit 12 further checks whether or not CHECK-OUT 144 read from the first storage unit 14 indicates “unused” (step S16). If CHECK-OUT 144 indicates “used” (step S16), control unit 12 determines that free-gift data for the product with the free-gift information received from terminal 21-23 has already been transmitted, and thus this process is ended.

If CHECK-OUT 144 indicates “unused” (step S16), control unit 12 extracts, from the second storage unit 15, free-gift data DATA 151 specified by DATA-ID 143 (step S17). Moreover, control unit 12 extracts, from the second storage unit 15, data of the download image for allowing terminal 21-23 to download DATA 151 corresponding to DATA-ID 143 (step S18).

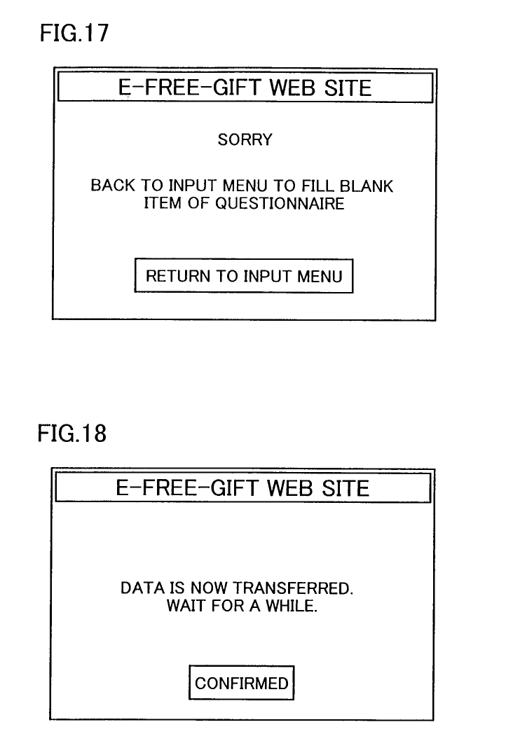

Referring to FIG. 15, when control unit 12 of distribution server 1 determines that the request for free-gift data from terminal 21-23 is irregular one, control unit 12 transmits, to terminal 21-23 via communication channel connection unit 11 and network 3, data of a re-input request image for requesting terminal 21-23 to enter the free-gift information again (step S19). Control unit 202 of terminal 21-23 thus receives the data of the re-input request image from distribution server 1 via communication channel connection unit 201 (step S20), and then outputs the received data of the re-input request image to display unit 205 which accordingly presents the re-input request image as shown in FIG. 17.

The user of terminal 21-23 uses operation unit 204 to select “RETURN TO INPUT MENU” on the re-input request image on display unit 205 (step S21), and control unit 202 transmits a notification of this selection to distribution server 1 via communication channel connection unit 201 and network 3. Receiving the notification, distribution server 1 transmits again data of the input image as shown in FIG. 12 to terminal 21-23 via communication channel connection unit 11 and network 3 (step S22). Terminal 21-23 thus receives the data of the input memu image from distribution server 1 via network 3, and the process returns to step S9.

Referring to FIG. 16, control unit 12 of distribution server 1 extracts the data of the download image from the second storage unit 15 in step S18, and transmits the extracted download image data to terminal 21-23 via communication channel connection unit 11 and network 3 (step S23). Communication channel connection unit 201 of terminal 21-23 thus receives the download image data from distribution server 1 via network 3, and writes the received download image data into memory unit 203. Control unit 202 reads the download image data from memory unit 203 and outputs the data to display unit 205 which accordingly presents the download image as shown in FIG. 7 or 8 (step S24).

If the normal download image as shown in FIG. 7 is displayed, the user of terminal 21-23 clicks “TRANSFER” on the display for obtaining normal free-gift data such as any part of a race car from distribution server 1. It is noted here that some free-gift data is premium data such as data of a special car. If the free-gift data corresponding to the free-gift information attached to the purchased product is such premium data, distribution server 1 transmits data of a download image for the premium data to terminal 21-23. Then, display unit 205 of terminal 21-23 presents the download image indicating “BINGO” as shown in FIG. 8.

Referring again to FIG. 16, the user of terminal 21-23 uses operation unit 204 to fill in the questionnaire indicated on the download image on display unit 205 of terminal 21-23 as required (step S25). Then, the user selects “TRANSFER” so that control unit 202 of terminal 21-23 transmits the questionnaire information entered by operation unit 204 to distribution server 1 via communication channel connection unit 201 and network 3 (step S26).

Control unit 12 of distribution server 1 receives the questionnaire information from terminal 21-23 via communication channel connection unit 11 (step S27) to determine whether or not required data is entered (step S28). When control unit 12 determines that the required data is not included in the questionnaire information or some of required data is not included (step S28), control unit 12 reads data of the re-input request image as shown in FIG. 17 from the second storage unit 15. Then, the process returns to step S19.

When control unit 12 determines that the required data is included in the questionnaire information (step S28), control unit 12 writes the received questionnaire information into the third storage unit 16 (step S29). Control unit 12 reads from the second storage unit 15 data of an image indicating that the free-gift data is now being transferred (transfer-in-progress image), and transmits the transfer-in-progress image to terminal 21-23 via communication channel connection unit 11 and network 3 (step S30).

Communication channel connection unit 201 of terminal 21-23 receives the transfer-in-progress image data from distribution server 1 via network 3, and writes the received transfer-in-progress image data into memory unit 203. Control unit 202 reads the transfer-in-progress image data from memory unit 203 and outputs the data to display unit 205 which accordingly presents the transfer-in-progress image (step S31).

FIG. 18 shows the transfer-in-progress image on display unit 205 that indicates free-gift data is now being transferred. The user of terminal 21-23 selects “CONFIRMED” and then distribution server 1 is informed of this selection to start transfer of free-gift data from distribution server 1 to terminal 21-23.

Referring again to FIG. 16, distribution server 1 receives from terminal 21-23 the notification that the transfer-in-progress image is displayed on terminal 21-23 and then transmits DATA 151 extracted in step S17 to terminal 21-23 via network 3 (step S32). Terminal 21-23 thus receives the free-gift data from distribution server 1 via network 3 to transmit in return to distribution server 1 notification that terminal 21-23 has received the free-gift data (step S33).

Control unit 12 of distribution server 1 receives the notification that the free-gift data has been received from terminal 21-23 via network 3 and communication channel connection unit 11 to update CHECK-OUT 144 corresponding to the product ID received from terminal 21-23 from “unused” to “used” and writes the updated CHECK-OUT 144 into the first storage unit 14 (step S34).

In this way, free-gift data is distributed from distribution server 1 to any product purchaser who has purchased a product with free-gift information attached thereto and desires to obtain free-gift data by the terminal of the purchaser (user).

The user of terminal 21-23 thus obtains the free-gift data which may be data of any part of a race car or data of a special car supplied as premium data. Then, the user can use such data by building the data into a car race game played on terminal 21-23.

The manufacturer or dealer of products may extract abundant questionnaire information stored in the third storage unit 16 of distribution server 1 for use in the marketing strategy and product development for example.

According to the above-discussed embodiment, the program in which free-gift data can be built is recorded on such a recording medium as CD-ROM (compact disk-read-only memory). The program recorded on the recording medium is read by recording medium control unit 24 shown in FIG. 10 into terminal 21-23.

The recording medium is any medium fixedly holding a program. Examples are such tape media as magnetic tape and cassette tape, such disk media as magnetic disk (flexible disk, hard disk for example) and optical disk (CD-ROM, MO (magneto-optical disk), MD (mini disk), DVD (digital video disk) for example), such card medium as IC card (including memory card) and optical card, and such semiconductor memories as mask ROM, EPROM (erasable programmable read-only memory), EEPROM (electrically erasable programmable read-only memory), and flash ROM.

In the above-discussed embodiment, the free-gift data and the program in which the free-gift data can be built are not limited to any game software-related data and program. The program and the free-gift data may be software for creating New Year's cards and illustration or format for the program, for example.

Further, in the above-described embodiment, network 3 may be any data communication channel by which two-way data communication is possible. Then, the network may be the Internet, LAN, telephone lines or mobile communication for example.

According to the above-described embodiment, three terminals are connected to network 3. However, any number of terminals may be connected depending on the number of users. Moreover, in addition to the mobile phone, such terminals as PDA (personal digital assistant), personal computer, mobile game machine and any information terminal equipment that can use the free-gift data as additional data and can be connected to network 3 may be employed.

Further, according to the above-described embodiment, respective image data displayed on terminal 21-23 are stored in the second storage unit 15 of distribution server 1. The image data may be stored in other storage units or a storage unit dedicated to image data.

According to the embodiment of the present invention, free-gift information attached to a purchased product is input by a terminal, according to which free-gift data is distributed via the network for building the free-gift data into a car race game played on the terminal and thus expanding/improving the game function. In this way, the purchaser of the product can readily obtain the free-gift data by the terminal. On the other hand, it is possible to continuously create consumers' desire to buy products with the purpose of obtaining free-gift data which can expand/improve the function of a car race game for example.

Moreover, according to the above-described embodiment of the present invention, free-gift data is distributed while the issue of irregular acquisition of free-gift data is addressed. Distribution of free-gift data at any irregular request, which does not contribute to sales promotion, can be prevented.

Further, according to the embodiment of the present invention, free-gift data is supplied on the condition that a questionnaire is filled in, which can increase the number of returned questionnaires relative to all questionnaires transmitted to the purchasers. From the abundant questionnaire information, any valid data may be extracted for use in analysis of products, sales promotion and product development for example.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A free-gift data distribution method of distributing free-gift data by a computer system to a terminal, said free-gift data being usable by said terminal as additional data, said method comprising the steps of:
receiving a first notification of requesting distribution of said free-gift data from said terminal;
transmitting, to said terminal according to said first notification, a second notification of requesting transmission of free-gift information attached to and specific to a purchased product;
receiving said free-gift information transmitted from said terminal according to said second notification;
checking said received free-gift information against a free-gift information list containing the free-gift information for all products that have been delivered to determine whether or not said received free-gift information is regular free-gift information attached to the product; and
transmitting the free-gift data corresponding to said received free-gift information to said terminal, when it is determined that said received free-gift information is regular free-gift information attached to the product.

2. The free-gift data distribution method according to claim 1, wherein
said free-gift information includes product identification information and password information assigned per said product for identifying said product.

3. The free-gift data distribution method according to claim 1, further comprising the step of transmitting, to said terminal, a notification of requesting re-transmission of said free-gift information, when it is determined that said free-gift information is irregular free-gift information attached to the product in said step of checking said received free-gift information against the free-gift information list containing the free-gift information for all products that have been delivered to determine whether or not said received free-gift information is regular free-gift information attached to the product.

4. The free-gift data distribution method according to claim 3, wherein
said free-gift information includes product identification information and password information assigned per said product for identifying said product.

5. The free-gift data distribution method according to claim 1, further comprising the steps of:
transmitting a questionnaire concerning said purchased product to said terminal; and
receiving said questionnaire from said terminal, wherein in said step of transmitting the free-gift data corresponding to said received free-gift information to said terminal when it is determined that said received free-gift information is regular free-gift information attached to the product, said free-gift data is transmitted to said terminal on the condition that requisite items of said received questionnaire are answered.

6. The free-gift data distribution method according to claim 5, wherein
said free-gift information includes product identification information and password information assigned per said product for identifying said product.

7. The free-gift data distribution method according to claim 1, further comprising the steps of:
determining whether or not said free-gift data has already been transmitted, based on transmission information of the free-gift data corresponding to said received free-gift information;
inhibiting transmission of the free-gift data corresponding to said free-gift information to said terminal, when it is determined that said free-gift data has already been transmitted; and
when it is determined that said free-gift data has not been transmitted, updating said transmission information from data indicating that said free-gift data has not been transmitted to data indicating that said free-gift data has already been transmitted, after said free-gift data is transmitted to said terminal in said step of transmitting the free-gift data corresponding to said received free-gift information to said terminal when it is determined that said received free-gift information is regular free-gift information attached to the product.

8. The free-gift data distribution method according to claim 7, wherein
said free-gift information includes product identification information and password information assigned per said product for identifying said product.

9. The free-gift data distribution method according to claim 7, further comprising the steps of:
transmitting a questionnaire concerning said purchased product to said terminal; and
receiving said questionnaire from said terminal, wherein in said step of transmitting the free-gift data corresponding to said received free-gift information to said terminal when it is determined that said received free-gift information is regular free-gift information attached to the product, said free-gift data is transmitted to said terminal on the condition that requisite items of said received questionnaire are answered.

10. The free-gift data distribution method according to claim 9, wherein
said free-gift information includes product identification information and password information assigned per said product for identifying said product.

11. A free-gift data distribution device for distributing free-gift data to a terminal, said free-gift data being usable by said terminal as additional data, comprising:
a communication unit for transmitting/receiving data to/from said terminal;
a first storage unit storing a free-gift information list containing the free-gift information for all products that have been delivered, said free-gift information being attached to and specific to the product, and a free-gift data identification code for specifying said free-gift data being associated with said free-gift information;
a second storage unit storing said free-gift data associated with said free-gift data identification code;
a determination unit obtaining said free-gift information list from said first storage unit and checking free-gift information received from said terminal against said free-gift information list to determine whether or not said received free-gift information is regular free-gift information attached to the product; and
a control unit providing said free-gift information received from said terminal via said communication unit to said determination unit and, according to the determination by said determination unit, obtaining from said second storage unit and transmitting to said terminal via said communication unit, the free-gift data specified by said free-gift data identification code associated with said free-gift information received from said terminal.

12. The free-gift data distribution device according to claim 11, wherein
said free-gift information includes product identification information and password information assigned per said product for identifying said product.

13. The free-gift data distribution device according to claim 11, wherein
when said determination unit determines that said received free-gift information is irregular free-gift information attached to the product, said control unit transmits, to said terminal, a notification of requesting retransmission of said free-gift information.

14. The free-gift data distribution device according to claim 13, wherein
said free-gift information includes product identification information and password information assigned per said product for identifying said product.

15. The free-gift data distribution device according to claim 11, wherein
said control unit transmits a questionnaire concerning the product which is purchased to said terminal via said communication unit, receives said questionnaire from said terminal via said communication unit, and transmits said free-gift data to said terminal via said communication unit on the condition that requisite items of said received questionnaire are answered.

16. The free-gift data distribution device according to claim 15, further comprising a third storage unit storing said questionnaire, as questionnaire information, received from said terminal via said communication unit.

17. The free-gift data distribution device according to claim 11, further comprising another determination unit determining, based on transmission information specified by said free-gift information received from said terminal, whether or not said free-gift data has not been transmitted, wherein
said first storage unit stores the transmission information of the free-gift data corresponding to said free-gift information, said transmission information being associated with said free-gift information attached to and specific to the product,
said control unit provides said free-gift information received from said terminal via said communication unit to said determination unit and to said another determination unit, obtains from said second storage unit and transmits to said terminal via said communication unit, the free-gift data specified by said free-gift data identification code associated with said free-gift information received from said terminal based on the determinations by said determination unit and said another determination unit, updates, after transmitting said free-gift data, said transmission information from data indicating that said free-gift data has not been transmitted to data indicating that said free-gift data has already been transmitted, and stores the updated transmission information in said first storage unit.

18. The free-gift distribution device according to claim 17, wherein said free-gift information includes product identification information and password information assigned per said product for identifying said product.

19. The free-gift data distribution device according to claim 17, wherein
said control unit transmits a questionnaire concerning the product which is purchased to said terminal via said communication unit, receives said questionnaire from said terminal via said communication unit, and transmits said free-gift data to said terminal via said communication unit on the condition that requisite items of said received questionnaire are answered.

20. The free-gift data distribution device according to claim 19, further comprising a third storage unit storing said questionnaire, as questionnaire information, received from said terminal via said communication unit.
